(19) United States
(12) Patent Application Publication
(10) Pub. No.: US 2005/0050980 A1
(43) Pub. Date: Mar. 10, 2005

(54) Pedal apparatus for a vehicle

(76) Inventor: Dae Deug Park, Gwangju-city (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/747,911

(22) Filed: Dec. 29, 2003

(30) Foreign Application Priority Data
Sep. 9, 2003 (KR) 10-2003-0063084

(51) Int. Cl. G05G 1/14

(52) U.S. Cl. 74/512

(57) ABSTRACT

A pedal apparatus of a vehicle according to the present invention comprises a supporting bracket fixed to a dash panel of the vehicle, a pedal arm pivotally connected to the supporting bracket, and a lever hooked to the pedal arm and applying a predetermined torque to the pedal arm, wherein the lever is struck by a striking portion under deformation by a front impact of the vehicle causing the pedal arm to rotate in a direction of the front of the vehicle by torque transferred from the lever.

### CROSS-REFERENCE TO RELATED APPLICATIONS

This application claims priority of Korean Application No. 10-2003-0063084, filed on Sep. 9, 2003, the disclosure of which is incorporated fully herein by reference.

### FIELD OF THE INVENTION

This invention relates to a pedal apparatus of a vehicle, and more particularly to a pedal apparatus of a vehicle for preventing a driver's foot from being damaged when a front impact is applied to the vehicle such that the pedal apparatus protrudes into a leg area.

### BACKGROUND OF THE INVENTION

Generally, a vehicle has several pedal assemblies, for braking, accelerating, and clutching, and each of the pedal assemblies comprises a pedal arm and a pad fixed to the end of the pedal arm.

A pedal assembly is rotatably connected to a supporting bracket which is fixed to a dash panel. Accordingly, if the driver operates the pedal assembly by applying force to the pad, the pedal arm rotates in a direction of the front of the vehicle with respect to the supporting bracket.

However, when a front impact is applied to the vehicle and the dash panel is deformed, the conventional pedal assembly protrudes into the leg area of the vehicle such that the driver's foot can be damaged.

### SUMMARY OF THE INVENTION

Embodiments of the present invention solve the above problems, and accordingly to provide a pedal apparatus of a vehicle having non-limiting advantages of preventing damage to a driver's foot caused by a protruding pedal assembly when a dash panel is deformed by a front impact.

An exemplary pedal apparatus of a vehicle according to an embodiment of the present invention includes a supporting bracket fixed to a dash panel of the vehicle, a pedal arm pivotally connected to the supporting bracket, and a lever hooked to the pedal arm and applying a predetermined torque to the pedal arm, wherein the lever is struck by a striking portion under deformation by a front impact of the vehicle causing the pedal arm to rotate in a direction of the front of the vehicle by torque transferred from the lever.

The pedal arm has a first pin pivotally connected to the supporting bracket and a second pin at the end of the pedal arm opposite to an end adhering a pad, and the lever has a third pin pivotally connected to the supporting bracket, a hook portion hooked to the second pin of the pedal arm, and an impact portion opposite to the striking portion.

The striking portion is defined as an additional structure formed on a dash panel or a mounting plate for a steering wheel.

The impact portion rotates about the third pin in the direction of the front of the vehicle such that the hook portion rotates about the third pin in a direction of the rear of the vehicle, and the second pin hooked by the hook portion rotates about the first pin in the direction of the rear of the vehicle such that the end of the pedal arm adhering a pad rotates about the first pin in a direction of the front of the vehicle.

The pedal apparatus may be a brake pedal apparatus or a clutch pedal apparatus.

In an alternative embodiment, the pedal apparatus comprises a pedal arm configured to be pivotably mounted to a dash panel with an upper end above the pivot and a lower, foot operated end below the pivot. A lever is pivotably mounted to the dash panel, with a first end engaging the upper end of the pedal arm and a second impact end extending opposite the first end. A striking member is disposed opposite the impact end of the lever such that deformation of the dash panel in response to a collision causes the striking member to strike the impact end of the lever which pivots such that the first end pulls the pedal arm to a retracted position. The pedal arm and lever are pivotably mounted to a bracket securable to the dash panel.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 illustrates a pedal apparatus of a vehicle according to an embodiment of the present invention;

FIG. 2 illustrates a pedal apparatus of FIG. 1 when a front impact is not applied; and

FIG. 3 illustrates a pedal apparatus of FIG. 1 when a front impact is applied.

### DETAILED DESCRIPTION OF THE PREFERRED EMBODIMENTS

An embodiment of the present invention will hereinafter be described in detail with reference to the accompanying drawings.

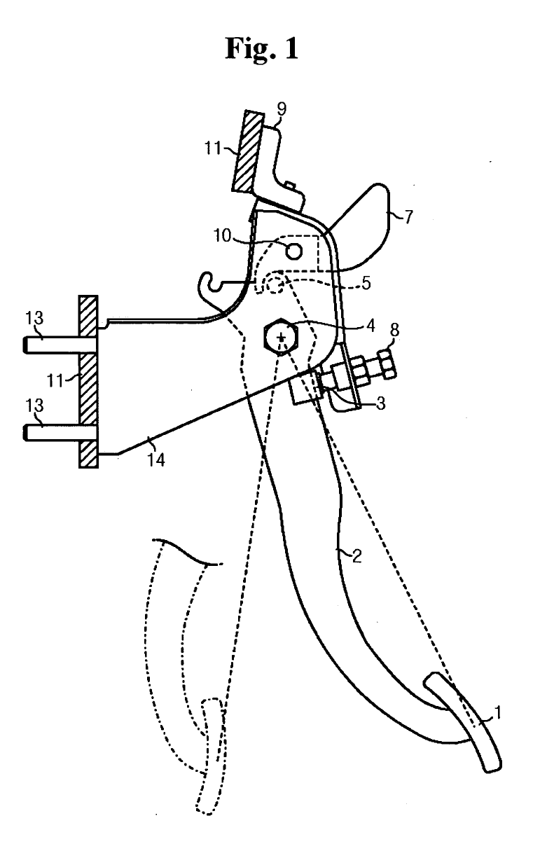

As shown in FIG. 1, the pedal apparatus includes a supporting bracket 14, a pedal arm 2, and a lever 7. The supporting bracket 14 is fixed to the front dash panel 11 and an auxiliary supporting bracket 9. The supporting bracket 14 is fixed to the dash panel 11 with bolts 13, and the auxiliary supporting bracket 9 interconnects the upper portion of the dash panel 11 and the supporting bracket 14.

The method of fixing the supporting bracket 14 to the dash panel 11 can be varied in accordance with the structure of the dash panel 11 of the vehicle.

The pedal arm 2 has a first pin 4, and a second pin 5 which is located at the end of the pedal arm 2 opposite to an end to which a foot pad 1 is adhered. The first pin 4 and the second pin 5 can be formed with the pedal arm 2 as one body, or they can be otherwise secured to the pedal, such as by welding. The first pin 4 is pivotally supported by the supporting bracket 14 such that the pedal arm 2 can rotate about the first pin 4. The pedal arm can be any one of the pedal arms provided in the leg area of the vehicle, preferably a brake pedal arm or a clutch pedal arm.

The lever 7 has a third pin 10 through which it is pivotally connected to the supporting bracket 14. It has a hook portion at one end and an impact portion at the other end. The hook portion of the lever 7 hooks the second pin 5, and the impact portion, with a general oval shape, backwardly protrudes through a slot formed in the supporting bracket 14.

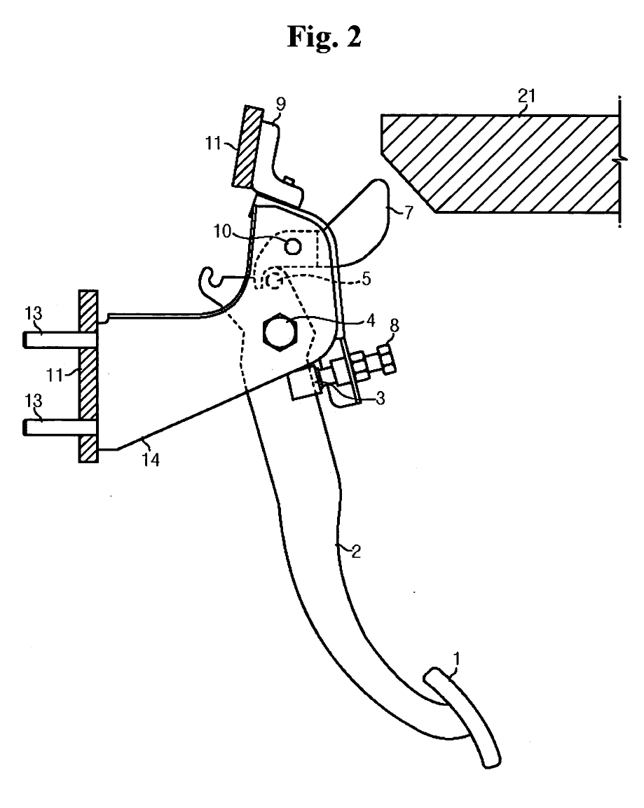

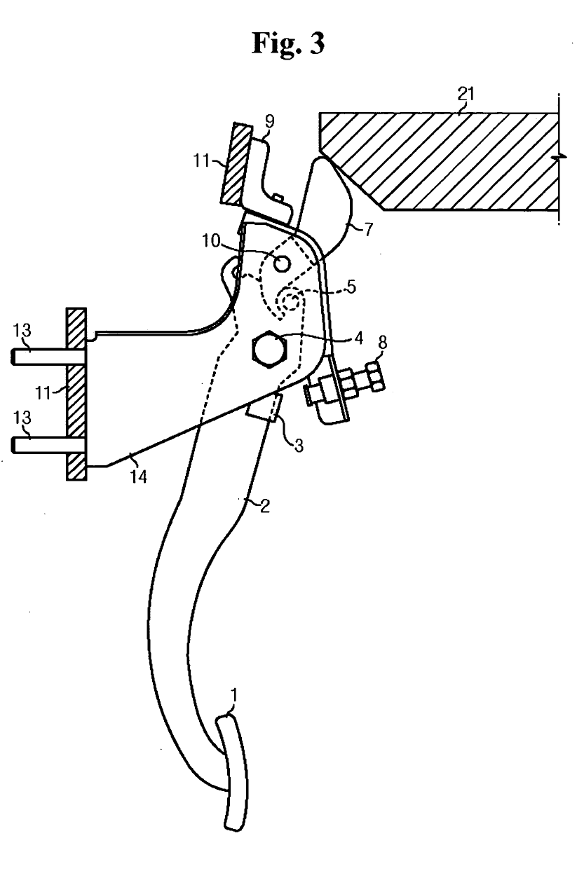

With reference to FIG. 2 and FIG. 3, a striking portion 21 is disposed to be opposite to the impact portion of the lever 7. The striking portion 21 is defined as an additional structure formed on the dash panel or a mounting plate for a steering wheel.

When a front impact is applied to the vehicle, the dash panel 11 is deformed which causes the lever 7 and the striking portion 21 to come together such that the striking portion 21 impacts the protruding impact portion of the lever 7 and the lever 7 rotates about the third pin 10 in a direction of the front of the vehicle.

Accordingly, the hook portion of the lever rotates about the third pin 10 in a direction of the rear of the vehicle such that the second pin 5 hooked by the hook portion is also pulled in a direction of the rear of the vehicle, causing the end of the pedal arm 2 protruding to the leg area of the vehicle to rotate about the first pin 4 in a direction of the front of the vehicle.

Consequentially, when a front impact caused by a car accident is applied to the vehicle, the end of the pedal arm 2 protruding into the leg area moves forward such that it is distanced from the driver so the possibility of damaged being caused by the protruding pedal arm 2 is decreased.

Additionally, a stopper 8, which comprises a bolt and nut, is mounted on the supporting bracket 14, and a supporting plate 3 is mounted on the pedal arm at the position opposite to the stopper 8. Accordingly, when the pedal is not operated, it is supported by the stopper 8 such that the position of the pedal arm can be adjusted.

According to the pedal apparatus of the present invention, when a front impact is applied to a vehicle, the pedal arm moves forward and is distanced from the driver such that that the possibility of damage being caused is decreased.

Furthermore, additional sensors or detectors are not required, such that even when the electric power is cut off owing to the impact applied to the vehicle, operation of the pedal apparatus can be guaranteed.

1. A pedal apparatus for a vehicle, comprising:
a supporting bracket fixed to a dash panel of the vehicle;
a pedal arm pivotally connected to the supporting bracket; and
a lever hooked at one end to the pedal arm, said lever being configured and dimensioned to be struck by a striking portion under deformation by a front impact of the vehicle causing the pedal arm to rotate in a direction of the front of the vehicle by torque transferred from the lever.

2. The pedal apparatus of claim 1, wherein:
the pedal arm has a first pin pivotally connected to the supporting bracket and a second pin at an end of the pedal arm opposite to an end with a foot pad; and
the lever has a third pin pivotally connected to the supporting bracket, a hook portion hooked to the second pin of the pedal arm, and an impact portion opposite to the striking portion.

3. The pedal apparatus of claim 2, wherein the striking portion is defined as an additional structure formed on a dash panel or a mounting plate for a steering wheel.

4. The pedal apparatus of claim 3, wherein the impact portion rotates about the third pin in the direction of the front of the vehicle such that the hook portion rotates about the third pin in a direction of the rear of the vehicle,
and wherein the second pin hooked by the hook portion rotates about the first pin in the direction of the rear of the vehicle such that the end of the pedal arm adhering a pad rotates about the first pin in a direction of the front of the vehicle.

5. The pedal apparatus of claim 4, wherein the pedal apparatus is a brake pedal apparatus.

6. The pedal apparatus of claim 4, wherein the pedal apparatus is a clutch pedal apparatus.

7. A pedal apparatus for a vehicle, comprising:
a pedal arm configured to be pivotably mounted to a dash panel with an upper end above the pivot and a lower, foot operated end below the pivot;
a lever pivotably mounted to the dash panel, with a first end engaging the upper end of the pedal arm and a second impact end extending opposite the first end; and
a striking member disposed opposite the impact end of the lever such that deformation of the dash panel in response to a collision causes the striking member to strike the impact end of the lever which pivots such that the first end pulls the pedal arm to a retracted position.

8. The pedal apparatus of claim 7, wherein the pedal arm and lever are pivotably mounted to a bracket securable to the dash panel.
